(19) United States
(12) Patent Application Publication
(10) Pub. No.: US 2019/0311604 A1
(43) Pub. Date: Oct. 10, 2019

(54) System, Device and Method for Asymmetric Panoramic Security

(71) Applicant: Skytech Security, LLC, Las Vegas, NV (US)

(72) Inventors: David Morehouse, Las Vegas, NV (US); Rhys Williams, Palmyra, VA (US)

(21) Appl. No.: 15/949,106

(22) Filed: Apr. 10, 2018

(51) Int. Cl. G08B 25/10; G08B 13/196; G08B 17/08; B64C 39/02

(52) U.S. Cl. CPC G08B 25/10; G08B 13/1966; B64C 2201/127; B64C 39/024; G08B 17/08

(57) ABSTRACT

A system, device and method deploys one or more cameras secured to ground-based and/or aerial devices along with one or more gunshot detection units (GDUs) to monitor an event for threats. Visual and audible signals received by the cameras and GDUs are sent to a central controller, which analyzes the received threat communications and issues appropriate communications according to a response protocol over a secure wireless network to intended recipients, including security/law enforcement personnel and members of the public attending the event. In various embodiments, a high intensity light source is provided for emitting high intensity light in the direction of any located gunshots or other relevant threat.

### TECHNICAL FIELD

The present invention pertains to security, and more particularly to a system, device and method for scanning, detecting, isolating and responding to threats.

### BACKGROUND AND SUMMARY

Challenges to public safety are climbing at an ever-increasing rate and scale of lethality. Present security solutions are not keeping pace with the apparent motivation of certain groups and individuals to bring about the physical destruction of life and property any place, at any time, for any reason.

Members of the public, especially at large gatherings such as outdoor events, concerts, sporting events, religious or cultural gatherings, celebrations and the like present target rich environments, in asymmetric fashion, to an ever-broadening spectrum of threats. Security for such gatherings lacks the skills and tools necessary to prevent or react in an effectual manner to protect public safety and prevent destruction of property.

Currently, no mobile security and/or surveillance systems exist to seamlessly address threats in public places and/or at public events. Furthermore, current security systems are not used in consonance to access, identify, and aggressively act to disrupt, delay, or deny the threat's planned objectives. Typically, it is not until a threat emerges and acts before law enforcement or security officers can react to the danger. Further, the actions of security personnel and law enforcement are driven by the limited amount of real time information available to them, forcing them to remain reactive, never proactive in their efforts as they relate to real or perceived threats to public safety and property. Law enforcement, firefighting and emergency medical services (EMS) are not designed for, nor are they ever deployed to large gatherings of people where threats now tend to congregate and “hunt.” The first responder protocol is driven by many variables, not the least of which is money and manpower, thereby mandating a response to threats immediately as they develop, or shortly after the intention of the threat has been carried out.

Invariably, time spent attempting the identify the source of the threat, and reacting to it, can translate into lives lost. This is a procedural, and informational hindrance to effective prevention of loss of life. Limitations in procedure and protocol, money and manpower continue to be rate limiters. Additionally, communications amongst Law Enforcement Agencies (LEA), Emergency Medical Services (EMS), and security officers can be confusing and ineffective. Further, the limits of 3G and 4G networks to handle increased emergency traffic at the critical point, as well as interoperability of radio networks within municipalities, and the absence of quality information pertaining to the nature and location of the threat and casualties, can also prove ineffective. For a wide variety of reasons, those responsible to scan, protect and react, simply cannot meet that requirement at the level the public wants or needs.

In addition to the above, current systems are not redundant, and they are especially devoid of real-time observation, collection, analysis and immediate direct action against real or perceived threat. Current systems also lack the ability for integration of collected data, analysis of this data, and more importantly, broadcasting of this data and/or analytical observations and instructions to police and EMS assets.

The system, device and method of the present disclosure addresses and remedies these issues.

In various embodiments, the system, device and method of the present disclosure addresses threats against persons and/or property, including acts of violence, utilizing vehicles of any kind, humans, or other methods of delivery, where such threats of violence, purposely or accidentally, are directed against life or property. The present disclosure applies equally to designated high-risk targets, including civilian and government facilities, as well as gatherings of any type involving people, or animals for whatever purpose. Potential threats can utilize any weapon or weapons system imaginable, whether chemical, biological, radiological, nuclear weapons (CBRN), and others, including any kind of explosive device or materials, manmade or not, including technical direct and indirect fire weapons, deployed by hostile groups or individuals, with the intent of causing death or serious bodily injury, or the destruction of property.

Embodiments of the present disclosure can also address complex force majeure events, including natural disasters where hostilities are possible before, during, or within the aftermath of natural disasters of any kind. In various embodiments, one or more cameras secured to ground-based and/or aerial devices are deployed along with one or more gunshot detection units (GDUs) to monitor events for threats. Visual and audible signals received by the cameras and GDUs are sent to a central controller, which analyzes the received threat communications and issues appropriate communications over a secure wireless network to intended recipients, including security/law enforcement personnel and members of the public attending the event. In various embodiments, a high intensity light source is provided for emitting high intensity light in the direction of any located gunshots or other relevant threat, in an effort to expose a hidden threat or temporarily reduce or remove the threat's visual ability. The system employs an evaluation and response protocol according to the present disclosure to address virtually any security situation where life and property are in jeopardy.

Through implementing the above, embodiments of the present disclosure scan potential threats before they happen and bring these potential threats to the attention of first responders for consideration or action, for example. In the event response to the threat shifts to a reactive mode, embodiments of the present disclosure can push visual and data information forward to first responders, as well as the public. As described herein, embodiments of the present disclosure provide a newly framed asymmetric and panoramic approach to public safety and property protection. In various embodiments, the present disclosure is directed to “events” involving gatherings of people, whether inside or outside. One or more protocols in accordance with the present disclosure can scan, detect, isolate and interdict virtually every threat present.

Through all of the above, and as described herein, the presently disclosed system, device and method provide a technical solution to the challenge of deploying threat detection devices in, at and around event perimeters, collecting and analyzing the threat detection communications, and implementing a response protocol with appropriate interdiction and security responses.

### BRIEF DESCRIPTION OF THE DRAWINGS

FIG. 1 is a schematic diagram of an event location with hardware elements according to embodiments of the present disclosure.

FIG. 2 is an architectural schematic diagram showing an implementation of a system in accordance with embodiments of the present disclosure.

FIGS. 3 through 5 are flow diagrams illustrating processes in accordance with embodiments of the present disclosure.

FIGS. 6 and 7 are illustrative screen shots illustrating informative displays in accordance with embodiments of the present disclosure.

### DETAILED DESCRIPTION OF EMBODIMENTS

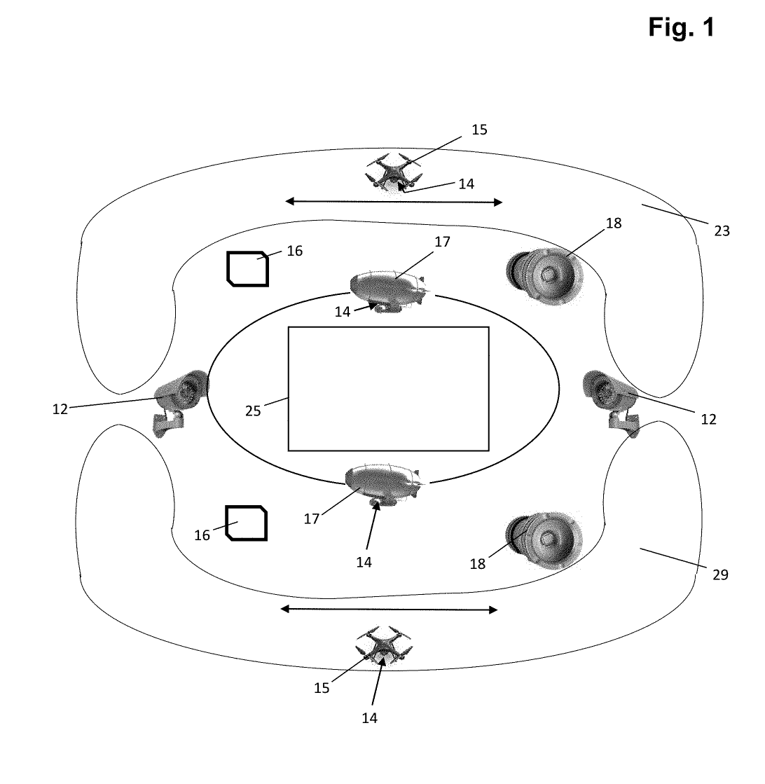

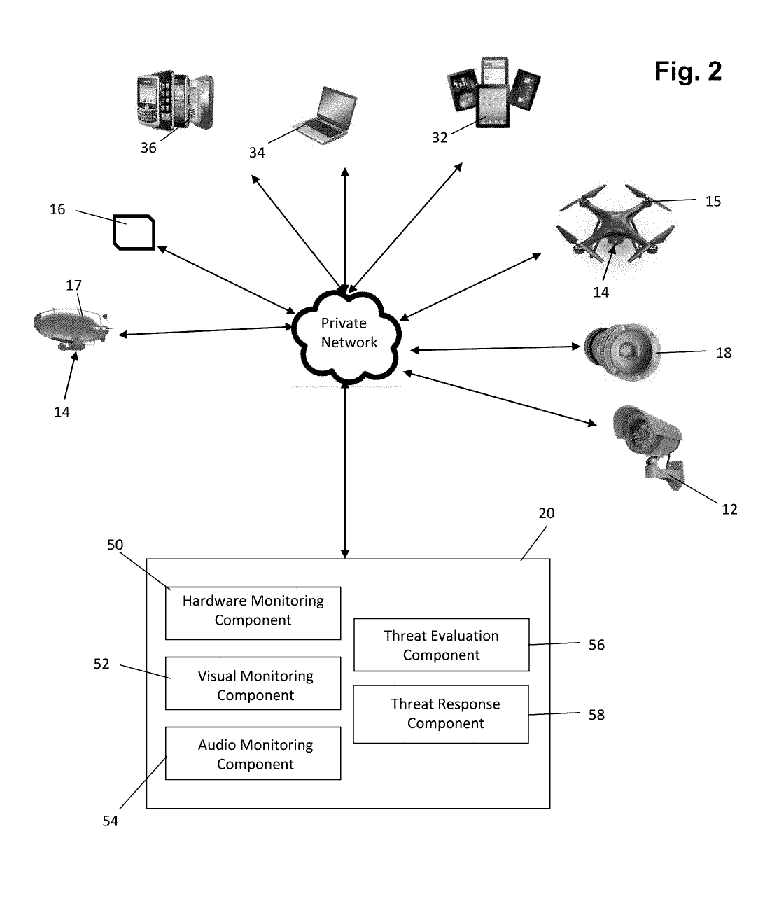

As shown in FIGS. 1 and 2, embodiments of the present disclosure can include a system 10 having one or more ground-based cameras 12, one or more aerial-based cameras 14, one or more gunshot detection units (GDU) 16, and one or more light units 18, such as a spotlight and/or high-intensity strobe light, for example. In various embodiments, the GDUs 16 can detect gunshots visually and audibly, for example, through cameras and microphones set up in multiple locations. In various embodiments, the GDUs 16 can be deployed at different locations on or near the perimeter of an event, and should gunfire occur, the microphone sensors associated with the GDUs can triangulate the origin of the noise.

It will be appreciated that the ground-based 12 and aerial-based 14 cameras can be controlled remotely, with the cameras secured to hardware such as a drone 15, blimp 17, platform and/or extendable mast, for example. The GDUs 16 and lights 18 can also be remotely controlled and secured to an aerial mobile device, such as a drone, blimp or mobile platform. In various embodiments, the aerial-based cameras 14 can be programmed with specific flight paths and observation maps, with takeoff and landing points that can be programmed in based on anticipated flight time, battery power and external conditions, such as weather, for example. A central controller 20 can be provided in communication with the above devices via network 22. While the network 22 can be a public network such as the Internet, in various embodiments, the network 22 is a high-powered, private wireless network and the central controller 20 is maintained in a secure environment, such as a mobile command and control room or vehicle, for example. Electrical power and appropriate charging devices are also provided as necessary for operation of the presently disclosed embodiments. The present disclosure further incorporates computer applications, such as mobile applications, for example, that can be customized for different user types. For instance, a law enforcement officer (LEO) can be provided with a LEO application and/or a gunshot detection application, an emergency services professional can be provided with an emergency services application and a public user can be provided with an emergency notification application.

The above-described devices 12, 14, 15, 16, 17 and 18 can be positioned to scan, detect, isolate and interdict potential threats. Depending upon deployment, the system 10 can focus on observing and anticipating the typically asymmetric nature of current types of threats, including outside the known perimeter of an event, and not necessarily on controlling gate admittance, patrolling the inside of a large gathering as a show of force, or immediately reacting to and seeking to quell disturbances within an event perimeter, for example. As shown in FIG. 1, the devices 12, 14, 15, 16, 17 and 18 are positioned outside of the perimeter 25 for a given event. In various embodiments, while one or more of the described devices may monitor visual or sound activities emanating from inside the event perimeter, the devices may also be predominantly focused outside of the event perimeter. In this way, embodiments of the present disclosure can establish three-dimensional layers of overlapping and interlocking security, by virtually becoming the eyes, ears, and hands of the security team. In various embodiments, the central controller operates an algorithmic protocol designed to push response information in real time to members of the public, law enforcement and other first responders based on threat communications obtained from one or more of the devices 12, 14, 15, 16, 17 and 18.

Each device can be explained in its sequence of deployment, the security area it is responsible for and the duties and responsibilities of technological experts necessary for the deployment, use and analysis of the security data the device provides.

It will be appreciated that, prior to any implementation of a system in accordance with the present disclosure, a security site survey may be conducted at a site of implementation. Such a site may typically be a location for a future gathering of people, which may be referred to herein as an “event”. It will further be appreciated that an event can be a scheduled one-time event, such as a concert, or a recurring event, such as school on weekdays, for example. Events can be public, private, indoors, outdoors, partially indoors and partially outdoors, as well as any variety of time, date, location and guests. There are no limitations to the physical properties of the event, its location, purpose or participants. The only constant is the need for security against known or unknown threats against the event. The site survey may follow a checklist used to determine the security situation relevant to the event, as well as the security considerations and actions deemed necessary to protect life and property at and during the event.

It will further be appreciated that an event perimeter can be known in the sense that it is an actual physical boundary (e.g., fencing or partitioning of an audience at a concert) or an artificially created boundary (e.g., thirty yards beyond all amenities (such as refreshment locations, bathrooms, entry gate, etc.) for an event).

After the site survey and analysis, a security map can be planned and laid out. FIG. 1 is an example schematic of a security map that may be employed, showing a known perimeter 25 for the event. As can be seen, the various devices can be positioned into a powerful series of interlocking, three-dimensional security zones designed to provide complementary technologies used to scan for threats, detect threats, isolate those threats and interdict those threats. Additionally, the system addresses communications and information transfer to not only first responders but the public as well.

Further, the panoramic aspects of the present disclosure include an ability to organize and use the devices described herein in a sweeping, expansive yet penetrating method to again look, listen and feel for threats in, around and outside of the event. Employing optical devices, acoustic devices, light devices and a host of ground and aerial platforms with technology payloads of varying types and applications, embodiments of the present disclosure permit nothing to go unnoticed or unaddressed within the event area of interest. The area of interest (AOI) can include the area outside and inside the known perimeter for an event, for example.

The central controller 20 provides programming for the analysis of visual, acoustic and other data, either automatically or with user evaluation and input. For example, a team of experts trained to recognize threats even before they develop or manifest can evaluate inputs from the various devices in order to assess a proper response. In various embodiments, every event is protected by experts in law enforcement, communications technology, emergency medicine, firefighting, commercial drone pilots, and/or technology application experts who each monitor their specific technology for functionality and effect, while effectively pushing the security product of their area of expertise forward into the hands of first responders for action.

As shown in FIG. 2, the central controller 20 can operate with various software programming such as a hardware monitoring component 50, a visual monitoring component 52, an audio monitoring component 54, a threat evaluation component 56 and a threat response component 58. The hardware monitoring component 50 tracks status and feedback information from the various devices deployed at a given event. For instance, the hardware monitoring component 50 may provide a user interface showing where cameras, blimps, masts, lights, drones and GDUs are activated and deployed, as well as the status of such devices, including anticipated remaining battery life (as applicable), environmental circumstances that may affect their operation (e.g., wind, temperature, structures), any malfunctions, and any devices held in reserve that may be deployed as back up devices. The hardware monitoring component 50 may also provide a user with the ability to ground or deploy such devices or dispatch maintenance personnel to fix such devices as necessary. Various user device types can be employed to interface with the central controller 20. For example, as shown in FIG. 2, tablet computing devices 32, laptops 34 and mobile communication/smartphone devices 36 can be employed. A user can access various user interfaces associated with the present disclosure depending upon their access permission and particular expertise, in various embodiments. For example, a user may employ a laptop (e.g., 34) in a command and control center for managing deployed equipment and/or analyzing feedback from a given device (e.g., 12, 14, 15, 16, 17, 18). Another user may employ a smartphone device (e.g., 36) to receive notifications from the system of the present disclosure, where such notifications can instruct law enforcement personnel, medical personnel, members of the public and other individuals about an occurring or recently occurred event and appropriate actions to be taken.

With further reference to FIG. 2, the visual monitoring component 52 coordinates the recording, retrieval, analysis and storage of all visual information detected and recorded by the devices, including video and/or still image surveillance. The audio monitoring component 54 coordinates the recording, retrieval, analysis and storage of all audio information detected and recorded by the devices. The threat evaluation component 56 analyzes the communications coordinated and received by the visual 52 and audio 54 monitoring components to assess the level and type of threat that may be involved. Such assessment contributes to the management of suitable responses to the detected threat, which are coordinated by the threat response component 58.

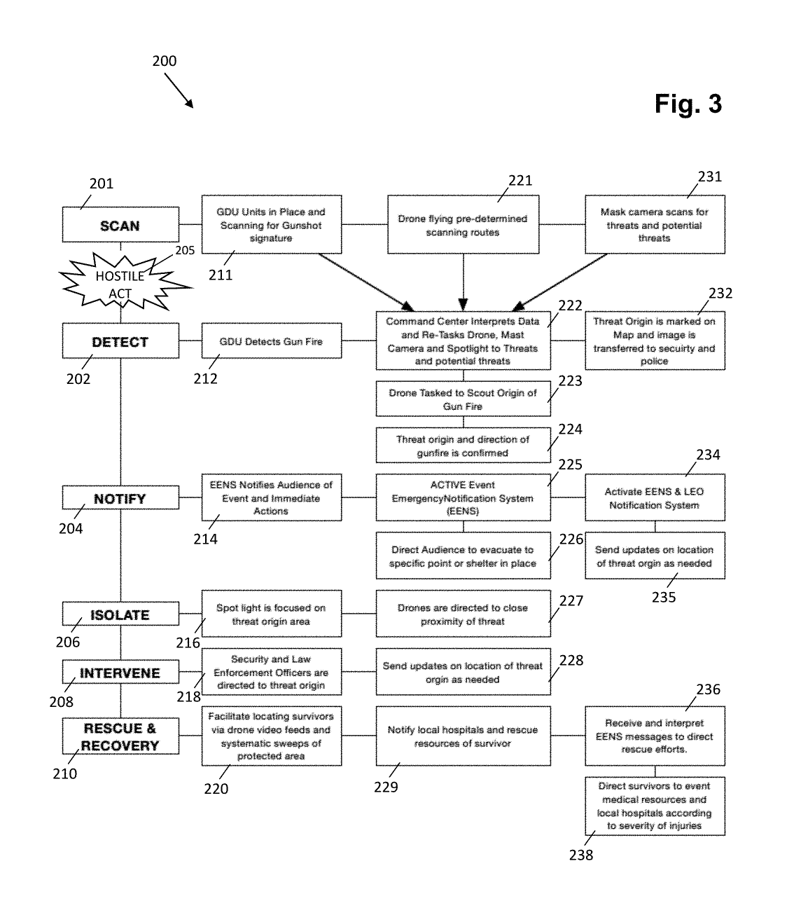

FIG. 3 illustrates an exemplary threat assessment and response in accordance with an embodiment of the present disclosure. As shown therein, general system functions are identified in the left column, including a scan function 201, a detect function 202, a notification function 204, an isolation function 206, an intervention function 208 and a rescue and recovery function 210. These system functions can be carried out electronically, although aspects of the entire operation may be carried out manually. For example, a law enforcement officer may receive a notification as part of the notification function 204, based upon the automated scan 201 and detect 202 functions; however, the law enforcement officer may physically move towards the perceived threat to intervene as part of the overall operation aimed at neutralizing the perceived threat. Similarly, personnel can be trained to receive or observe incoming data from the scan 201 and detect 202 functions, whether it is visual, text, radio, etc., and respond to that data based on algorithms as described herein. The automatic and/or algorithmic approaches can mitigate emotional responses to event occurrences, e.g., active shooter, bomber, gang activity. These algorithms “standardize” actions, ensuring there is a direct, accurate and proactive response from the central controller (e.g., command and control) as the system pushes out messaging to first responders, e.g., police, fire, EMS personnel.

As further shown in FIG. 3, embodiments of the scanning function 201 can include gunshot detection units (GDUs) being physically positioned in and/or around an area of interest, and having the GDUs scan for gunshot signatures, as at 211. As described in connection with FIG. 1 above, the scanning function 201 can also include one or more drones flying pre-determined paths, as at 221, as well as a camera scanning for threats or perceived threats as at 231. The camera can be attached to a mast, for example, as described above. Should a hostile act occur, as at 205, the detect function 202 can perform multiple operations, including the GDU detecting gun fire as at 212, the central controller interpreting the incoming information and optionally re-directing the one or more drones, mast cameras and spotlight to the threat/potential threat as at 222. The perceived threat origin can also be marked on a map, with the map image(s) transferred to law enforcement and any other necessary personnel, as at 232. As part of this operation, the central controller can re-task the drone to scout the origin of the gun fire, for example, as at 223, and the threat origin and direction of gunfire can be confirmed, as at 224.

As shown in connection with the notification function 204 in FIG. 3, the EENS app can notify the intended audience of the event and immediate actions necessary for safety and protection, as at 214. As part of this operation, the central controller can engage the EENS and

LEO apps at 225 and 234. The EENS app can inform the audience to evacuate the location to a certain point, shelter or direction(s) as at 226, and the LEO app can inform law enforcement and other first responders to the location of the threat origin as at 235. The location of the threat can be updated over time, such that if a perceived perpetrator is moving around after initiating gunfire or other hostile act, the system can adapt to notify appropriate personnel accordingly. As part of the isolation function 206, the central controller can direct the high intensity light to focus on the threat origin area as at 216, and mobile cameras can be re-directed to be closer in proximity to the perceived threat as at 227. By focusing the light, security personnel can see a potential threat better, and the light may reduce or remove the ability of the threat and/or perpetrator to see, thereby thwarting the ability of the threat to cause further damage, injury or death.

The intervention function 208 operates such that security and law enforcement personnel can be directed by the central controller to the threat origin as at 218, with updates provided as at 228. The rescue and recovery function 210 operates to facilitate the location of survivors and other people or assets by using, for example, mobile cameras providing video feeds to the central controller as at 220, which can involve periodic sweeps of the area of interest. Local medical services such as hospitals and rescue personnel can be informed of location and possibly the condition of people involved, as at 229. For example, personnel can receive a notification via mobile device to direct rescue efforts as at 236, and survivors can be directed to appropriate medical resources, as at 238.

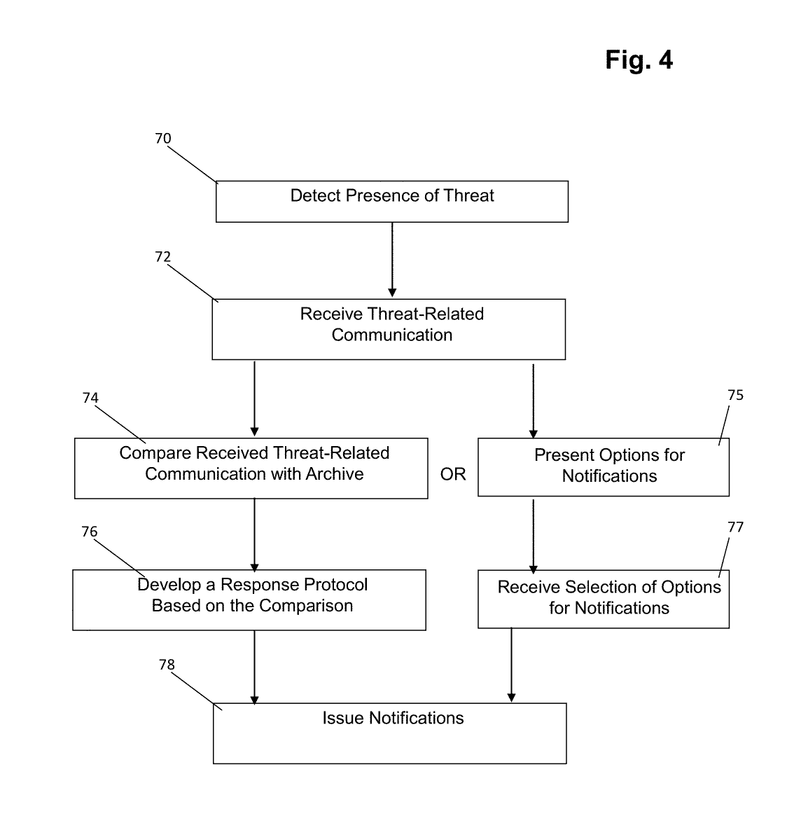

FIG. 4 illustrates another exemplary threat assessment and response in accordance with an embodiment of the present disclosure. As shown at step 70, the presence of a threat is detected by one or more deployed devices, such as a camera 14 on a drone 15 patrolling outside of the known perimeter of an event. Such a threat may be detected based upon motion, smoke or other visual indicator, or based upon sound, for example. As at step 72, the central controller receives a communication about the threat from the detecting device. In the camera example, the threat communication may be a video of a gun extending from a tree outside the known perimeter. As at step 74, the threat evaluation component 56 can compare the received threat-related communication with data in a database of previously established threat-related communications, and at step 76, can develop a response protocol based on the received threat-related communication. In various embodiments, developing a response protocol can include retrieving a response protocol associated with the scenario, gun, noise, etc. most similar to the scenario, gun, noise etc. involved with the event and the detected threat. For instance, if the system detects a gunshot and records the gunshot sound, it can compare the recorded acoustic fingerprint with previously stored acoustic fingerprints of weapons to provide a response, including an identification of the type of weapon and appropriate notifications. As every rifle or pistol has a unique acoustic fingerprint, the present system can assess whether the weapon may be a nine-millimeter pistol or a high-powered 300 Winchester Magnum™ rifle, or any firearms that create an audible report regardless of whether the weapon has a noise suppressor and whether it has been fitted with a flash hider, for example.

After the threat-related communication is received, the threat response component 58 can present options for notifications to a user for selection, as at steps 75 and 77. For instance, the threat response component 58 may determine that a map of the venue with written instructions should be sent to law enforcement officers, and may prompt a user to select a large map or a small map, and may further prompt a user to select or enter text to be sent to the mobile devices of law enforcement officers. Alternatively, a mobile application may already display a map and status information for the devices deployed at a given event, and the threat response component 58 may determine that messages and display changes should be sent to emphasize instructions and highlight specific areas (e.g., dangerous areas may be shown in the color red). As a further alternative, the threat response component 58 can empower users, such as staff in a control room, to manually enter a suitable response. Once the response is determined and/or selected, appropriate notifications can be sent, as at step 78.

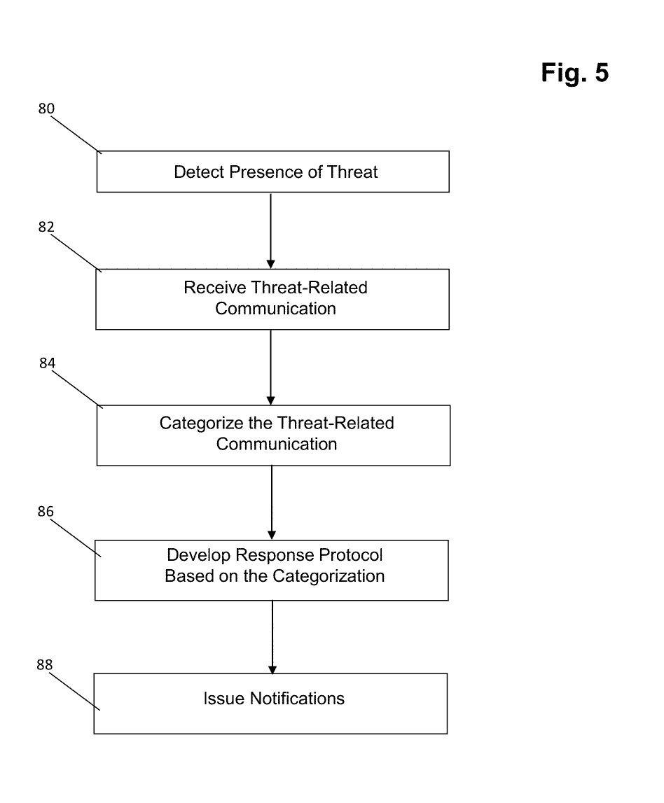

FIG. 5 illustrates an additional exemplary threat assessment and response in accordance with another embodiment of the present disclosure. As shown at step 80, the presence of a threat is detected by one or more deployed devices, such as a camera 14 on a drone 15 patrolling outside of the known perimeter of an event. As at step 82, the central controller receives a communication about the threat from the detecting device. As at step 84, the threat evaluation component 56 can categorize the received threat-related communication, and at step 86, the threat response component 58 can develop a response protocol, where the protocol provides selection options for issuing notifications associated with the categorized threat, for example. In various embodiments, developing a response protocol can include retrieving a response protocol associated with the categorized threat. For example, the threat evaluation component may categorize the threat-related communication as a specific type of rifle shot, with a suppressor, coming from the southeast corner of the known perimeter. The response may then be assessed automatically, with notifications directing attendees to exit from the furthest possible section of the known perimeter away from the perceived threat, and with security personnel directed to intervene at the location of the perceived threat. Once the response is determined and/or selected, appropriate notifications can be sent, as at step 88. In various embodiments, notifications are issued simultaneously, while in other embodiments, notifications are issued at different times according to need.

In various embodiments, the system includes a secure private wireless network (e.g., 22) and one or more applications associated with various user types. The private wireless network can connect GDU units 16, cameras 14, drones 15, blimps 17, and other electronic security devices in a fashion that cannot easily be interrupted or degraded. This system includes the ability to enroll selected personnel into it, thereby preventing a shutdown due to overload and excessive traffic. Furthermore, the network 22 can be limited to one-way communications traffic, meaning, only voice, visual or data traffic is transmitted from the central controller out to first responders and event participants via corresponding applications (APPs). In addition to a LEO app and an EENS app, the system can include a GDU app and a medical services app, among others. It will be appreciated that the various apps may share data in various embodiments. For example, data from the GDU app can be cross-fed into the LEO app depending upon the situation. The controlled one-way traffic can ensure the system remains up and functional during all phases of the event whether before, during or after the security monitoring of the event.

In various implementations, the wireless communication technology utilizes Wi-Fi access points, mesh access points, switches (Power Over Ethernet or otherwise), and routers, along with other networking equipment to connect electronic security devices in a closed network via a central router. This router has access to the internet with a temporary connection via an Internet Service Provider (ISP), for example. The Wi-Fi technology can be left in place or taken down depending on the needs of the venue. For example, for recurring events at the same venue, the equipment may be left in place and re-used for the next event.

The Law Enforcement Officer (LEO) application can integrate real-time video and interactive map data via web and local server, in accordance with aspects of the present disclosure. Data can include live video feeds from drones, mast camera, blimp and fixed wing camera feeds and interactive maps of gunshot detection units (GDU) to police and rescuers to facilitate the mitigation of threat and the seamless rescue of injured persons. The LEO application can include several components and functions, which include local server, cloud-based video stream, web based administrative access point, data streams from drones, gunshot detection units, artificial intelligence servers, and text distribution software. In various embodiments, the notification system integrates numerous data points that are selected from the on-site command and control center and streams them via local and cloud-based servers to web links that police and rescuers can use in real-time to mitigate threats. FIG. 5 is an example display 100 on a mobile device 102 authorized for the LEO application. As shown therein, a textual message section 104 is provided, with a message from the central controller indicating a threat (“shots fired from NW exit area of event”) and an instruction sent to attendees (“attendees directed to evacuate from NE and SE exits”). Such message section informs the authorized personnel of current activity so that the personnel can take action accordingly, such as, for example, proceeding to track the threat or securing safety for attendees. A visual display section 106 is also shown, which in this case includes a map or image of the event location and/or perimeter 110, key map elements, such as exits 112, and threat locations 114, such as where gunfire was detected.

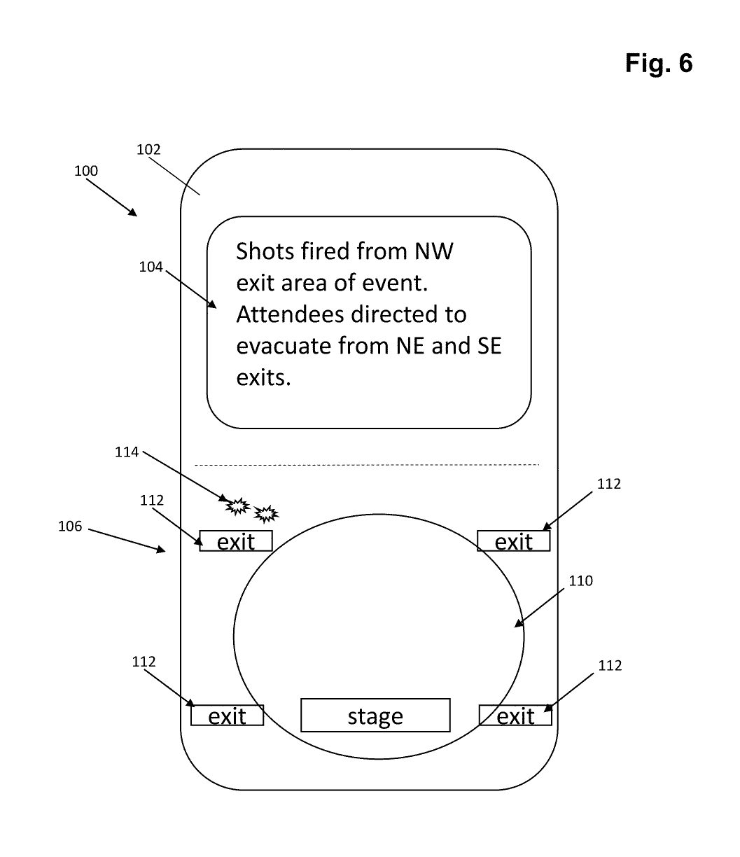

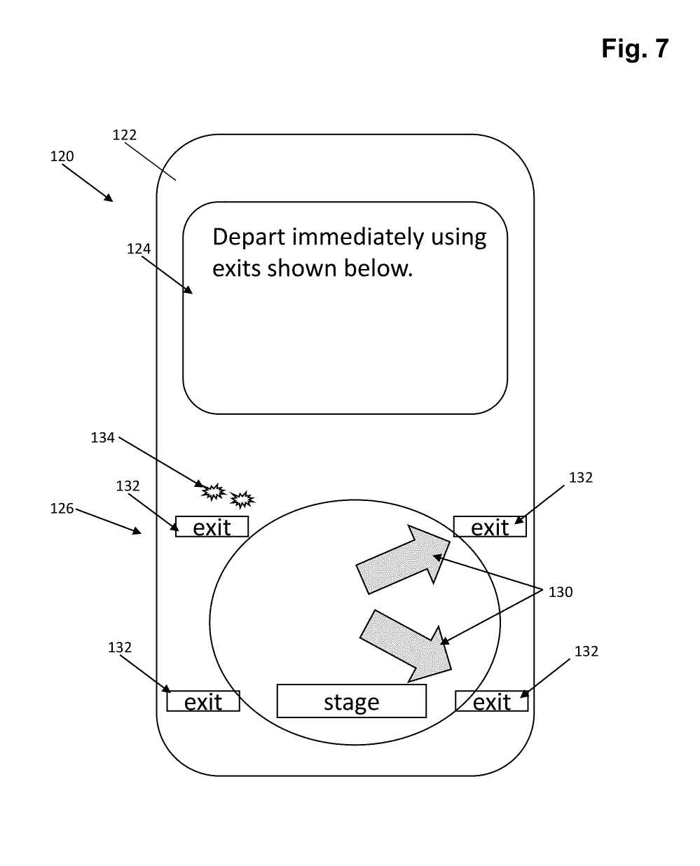

The Emergency Event Notification System (EENS) application can, among other things, notify event audience members of emergencies in real-time with specific evacuation guidance provided by event emergency management personnel. The EENS application can include several components and functions, including a text message notification system, custom evacuation maps designed for each specific venue, and evacuation route editing software that allows emergency management personnel to modify and send evacuation routes to audience members within seconds. The EENS application can also provide directions to medical support stations and local hospitals based on type of injuries, for example. The EENS application's unique features include custom designed evacuation routes from event location, which are transmitted to audience attendees to divert the audience away from threats. Messages can have an interactive map that allows the receiver to select police and medical assets in their area with directions. Audience members can also send messages requesting assistance and allow their location to be sent with the message, in various embodiments. FIG. 6 is an example display 120 on a mobile device 122 authorized for the EENS application. As shown therein, a textual message section 124 is provided, with a message from the central controller indicating an instruction sent to attendees (“depart immediately using exits shown below”). A visual display section 126 is also shown, which in this case includes a map or image of the event location with key indicators 130, key map elements, such as exits 132, and threat locations 134, such as where gunfire was detected.

### Drones

Embodiments of the present disclosure can utilize several types of commercial drones, including, for example, patrol drones, interdiction drones, and resupply drones. Drones from SZ DJI Technology Co., Ltd. of China can be employed, for example. The critical work of any category of drone, is to carry the eyes, ears and hands of the system, reaching as far outside the event's known security perimeter as deemed necessary. While other complementary technologies look and listen for threats, the drones are an active presence and thereby a clear deterrence to potential threats. As mentioned, the drones actively scan to detect threats, and once identified and/or detected, the drones are used to isolate the threat by broadcasting its location, providing video of the threat, its size, what it might be armed with, and/or its current actions. Depending on the directives and established cooperation agreements (COAs) between law enforcement and system operators, these drones can be used to interdict the threat with high-intensity lights or speakers.

It will be appreciated that a principal embodiment of the drones features one or more dual gimballed, high-resolution cameras mounted to the drones. Such drones can see far away, allowing the drones to maintain a suitable standoff distance for safety, or, they can move in close to be seen and heard, depending on the mission and needs of law enforcement. Furthermore, the drones and their cameras can see just as well in the darkness as they can in daylight. The cameras can be equipped with telephoto lenses and Forward Looking Infrared (FLIR), for example. Each drone is in a class capable of being dual gimballed, meaning, a separate remote-controlled gimbal exists for each type of camera.

Embodiments of drones employed with the present disclosure can see during daylight hours, and they can see deep into the darkest recesses of any urban terrain surrounding the event. This capability means nothing detected can escape the eyes and ears of the drones. Once detected, threats cannot easily escape the eyes of the drone, which can follow them from afar, or, follow them from above while the system and/or commercial drone pilots push a constant, high-resolution image to law enforcement and other first responders. In various embodiments, law enforcement officers remain in constant contact with the central controller of the present disclosure so they might direct and redirect the position of the drones to give them the best possible vantage point and video images.

Utilizing a thermal imaging camera and/or telephoto capabilities, law enforcement can be shown the threat or threats, what they are armed with, if they are running, where they are running, if they have tossed their weapons, or if they have collected more weapons. Whatever the threat does, it is watched, and can be broadcasted over a network (e.g., 22) to those who will actively interdict it.

Patrol drones employed according to the present disclosure are smaller, faster and generally have a longer battery life. They are designed to fly electronically designated flight routes, utilizing onboard software to control the drone's altitude and flight path. As shown in FIG. 1, there may be multiple patrol drones 15 flying a pre-programmed path (e.g., 23, 29) outside the known perimeter 25. This system permits the pilot to control the camera gimbals and search for possible threats. Because these drones are lighter and faster, they can stay aloft longer and cover more ground in the air looking for threats. When they are required to return to base for a battery change and maintenance, if required, another drone is programed to take its place in the flight paths so the patrolling never ceases for the duration of the security event.

Interdiction drones employed according to the present disclosure are heavier commercial drones designed to carry more weight (e.g., up to fifty-five pounds or more). In addition to their high-resolution cameras, they can carry an array of active systems, from loud speakers, to high-intensity strobe and spot lights. Due to their weight and payload, they have shortened time on station; however, they are highly effective. While patrol drones can continue to provide “eyes on” the threat, the interdiction drones can be used to relay verbal commands from law enforcement, or, the high intensity strobe and spotlights can be used to pinpoint the threat or hamper the threat's ability to effectively carry out its intended mission.

Due to the shortened battery life, multiple drone packages can be employed to constantly replace the interdiction drones as they divert for battery replacement or payload reconfiguring. This is entirely dependent upon the threat at hand, and directives or needs of law enforcement or other first responders, for example.

Medical Resupply Drones employed according to the present disclosure are capable of carrying a payload of basic trauma related medical supplies. The exact payload package can be determined by a medical director and is specifically designed to make use of those items most medics (EMS) typically run out of during a mass casualty incident. In a specific example, each trauma package carried by an M-Drone (medical drone) can consist of:
a). tourniquets
b). pressure bandages
c). crinkle gauze wrap
d). emergency pill pack
e). chest seals
f). NPAs

In an exemplary deployment, a radio call is received from EMS personnel within the security area, whereby a certified drone pilot will fly the M-drone from the vicinity of the command and control location, to the EMS provider's location. Once the location is confirmed, the M-drone can land and drop its payload, or, in the event of conditions prohibiting landing, the drone pilot can actuate the drone's payload, and drop it to the EMS provider.

In various embodiments, preparations for each event include providing sufficient pre-packaged medical drop supplies, necessary to support the event, depending on the size of the event. The M-drones can continue to fly these resupply missions until the need is reduced or eliminated, or when the situation no longer supports resupply.

It will be appreciated that embodiments of the system provide a panoramic net of recorded visual surveillance data utilizing high-speed camera drones to patrol at various altitudes and distances from the event perimeter. The drones can be encased in circular wire cages (also known as ball drones) to protect against obstacles (e.g., buildings, wires, trees, etc.) and mitigate threats to individuals. These “electronic eyes” tirelessly monitor, record, broadcast, and respond to threats utilizing an array of standard, thermal, eulerian, and telephoto lenses.

In embodiments, the system will deploy drones to pinpoint the threat and begin collecting visual data. Coaxially mounted lasers can be utilized to further pinpoint the threat to the naked eye, while other interdiction tools work to disrupt and deny the threat's ability to act on its mission.

For example, a panoramic drone net can watch from the ground up, or from the highest surrounding structures down, with a 360-degree asymmetric capability. These piloted drones can maneuver to various positions where a threat might locate themselves, trying to hide while the execute their intentions, e.g., in surrounding buildings or on rooftops, in heavy foliage or rock formations outside the security perimeter, or, possibly in and amongst crowds of people.

In various embodiments, the drone security sub-system utilizes night vision, thermal or standard camera mounted drones to aggressively patrol outside of the established event security area. While the drones are a mobile platform of eyes and direct response, a ground-based or tethered (stationary) camera support can be provided, such as blimps, or fixed, stationary pneumatic mast mounted cameras. This varied and capable array of platforms allows the presently disclosed system to position precisely the optimum technology, in exactly the correct place, at the perfect altitude and direction, to provide the most usable security information. Each of these systems provide additional layers of security coverage.

### Tethered Blimps

During periods of high wind, it can be necessary to temporarily limit drone flight. In such situations, tethered blimps (e.g., 12 to 16-foot long, or larger depending on the size of the venue) can be mounted at and around the known security perimeter (e.g., at four corners of the perimeter or in a central area depending on the size and configuration of the venue). These systems can be tethered to the ground by a small towing trailer or placed on a mobile truck platform, which contains the support systems and metal cable used to hold the blimp in place, for example. In embodiments, each blimp is mounted with a remote-controlled gimbal, and the payload, which can exceed 50 or more pounds if needed, can consist of standard cameras, FLIR cameras, high-intensity spot and strobe lights, as well as laser designators, loud speakers, even acoustic or optical gunshot sensors. Such implementations become a principal aerial camera source in high winds. In various embodiments, the length of tether can range from 25 feet to 300 feet depending on the security site survey and surrounding structures and terrain. There are naturally some limitations which can be established by a site survey. Each technology mounted as part of a blimp's payload can play a role in determining the ideal altitude the blimp should fly in order to optimize performance.

### Telescoping Masts

Pneumatic masts or other types of powered, telescoping masts can also be employed. These light-weight, yet ultra-strong masts can be trailer mounted, and can be raised utilizing compressed air, or an onboard air compressor to raise and lower the mast (e.g., from 10 feet to a height of 75 feet or more). In various embodiments, the top of the mast-head is a T-bar, which carries a wide variety of payloads. In various embodiments, high-intensity strobe lights, and 10,000 lumen spotlights can be mounted atop this platform, which is then raised above obstacles to permit the controller, inside the command and control room, to point the lights toward any suspected or defined threats. The ability to see where the light is pointing can be provided via a coaxially mounted spotting camera, the image of which can be automatically monitored by the system and/or monitored by personnel responsible for the deployment of the masts and their payloads, for example.

In addition to gimbal mounted cameras (all types), lights and lasers, this platform supports the mounting of acoustic and/or optical gunshot detection sensors. Power for each of these systems, from cameras, gimbals, lights and sensors is provided by a power cord, which rides alongside the mast sections. However, battery or solar power units can also be mounted atop the mast head.

### Gunshot Detection Units (GDU)

In various embodiments, the presently disclosed system employs two types of gunshot detection (GDU) technologies, relying on both to overlap and support the intended outcome of providing the most accurate and timely information to law enforcement as to the direction, distance and altitude of the source of any gunshots. Exemplary GDUs from V5 Systems Inc. of Fremont, Calif. can be employed. In embodiments, the GDUs utilize an algorithmic application to pinpoint the source of the gunshots and immediately provide information regarding the elevation of the threat, as well as providing a directional azimuth and distance from each individual GDU. This information can provide the exact location of the gunshots, to within one meter, in various embodiments. In various embodiments, the GDUs incorporate acoustic and optical detection capabilities.

Additionally, the GDU can transmit information, overlaid on a virtual map (e.g., Google™ Maps) of the designation security area. The overlay identifying the source of the gunshots can be rapidly transmitted by the central controller to selected smart phones, tablets, and computers, as well as being seen on large displays within a command and control room. In various embodiments, the system does not rely entirely upon one or the other of the two technologies (acoustic or optical). However, each device may rely upon different methods of detection, therefore, the security situation, terrain, conditions and more may dictate a heavier reliance on one or the other for that period of use.

### GDU Acoustic Detection

The acoustic systems can listen for the projectile's shockwave, also known as the “bullet bow shockwave” and quickly use this acoustic information to triangulate the location of the source of the sound. This shockwave can be detected as the bullet passes the sensor, or, it can be detected from the muzzle blast of the weapon creating the shockwave, or both. This acoustic capability can reach long distances outside the perimeter of the protected event. This perimeter increase pushes well beyond line-of-sight, adding significant protection to life and property.

### GDU Optical Detection

Optical GDUs, also known as “electro-optical” systems, can be deployed in connection with the present disclosure, and are trained to detect a combination of visual data. The system can see the bright light of the muzzle flash when a gun is fired, for example. In embodiments, the optical sensors can also see the heat signature caused by the friction of a single bullet moving through the air. These visual sensors require a line-of-sight from their location to the actual point of shots fired, or, to the flight path of the projectile.

### GDU Architectures

Embodiments of the present disclosure can employ “wide-area acoustic surveillance,” or a distributed sensor array, as an architecture. This architecture or protocol allows for an extended reach outside the event security perimeter. The distributed sensor array has a distinct advantage over other systems in that it can successfully classify gunfire with and without hearing a projectile “snap” sound, even amid heavy background noise and echoes, e.g., at an outdoor concert event, or large sporting event. In accordance with embodiments of the present disclosure, GDUs are trained to detect gunfire across an urban landscape, covering many square miles.

Deployment of the systems can utilize several different methods depending on the security situation. For instance, GDUs can be mounted on pneumatic masts, which raise them high above acoustic or visual obstacles along the event perimeter. These masts can be lightweight, mobile devices capable of raising the GM and its power units (solar, battery or AC) to any height up to eighty feet or more above ground level. GDUs can also be mounted on tethered blimps, which can be raised to any level up to 100 feet in height or more above ground level. These blimps are quiet, fixed platforms, capable of raising the acoustic or visual GDU systems and their power supply (solar, battery or AC) to whatever level the security situation, terrain and situation require. GDUs can also be mounted on commercial drones, not to exceed a certain weight, in various embodiments. This deployment system, while effective, can be limited by battery (DC) power. In instances where, for example, an event is held in an area where the surrounding terrain will not support the location of a pneumatic mast, or, perhaps a tethered blimp, drones can be employed. In such cases, drones can be used for deployment of GDUs up to a wide variant of altitudes to look and listen for gunshots.

### GDU Application Notification

It will be appreciated that knowing where a gunshot came from is of no security value unless it is presented to the first responders responsible for reacting to it. The GDU sub-system can use an application designed to overlay an electronic map with a symbol representation of direction, distance and elevation, as well as the shooter or shooters, which is provided to local law enforcement as quickly as the data is analyzed by the system, which is typically seconds, to a few minutes. The system can also push simpler forms of data as text information regarding the direction, distance and elevation of the shooter or shooters. Often, due to bandwidth, or other data flow restrictions, this capability is relied upon to ensure information is furnished to responders as quickly as possible and is not bogged down in the application awaiting the generation of an electronic map.

If the threat presents as a shooter, the panoramic net of the present disclosure utilizes mobile and static acoustic gunshot detection units (GDUs), to immediately triangulate the shooters location and transmit this information to the command and control trailer, where it is filtered, organized and prioritized before being pushed to law enforcement (LEA), emergency medical services (EMS), and other designated parties. If a shooter surfaces with lethal intent, the location can be quickly determined, with continuing broadcasting to LEA and EMS units as they move into position to respond.

### High-Intensity Spotlights

In various embodiments, the security system employs gimbal mounted, remote controlled, coaxial mounted aiming camera, spotlights. Exemplary lights can be provided through Larsen Electronics LLC of Kemp, Texas. These lights are 10,000 lumens plus, depending on the security assessment and mission. The LED beams are strong, adjustable, and can be deployed as DC, battery powered, or as solar powered (converted) units, for example. These devices can come to bear during the isolation and interdiction phases according to the present disclosure, in various embodiments. Once a threat has been identified during the scanning and detection phases, the system can use light, amongst other technologies to isolate a suspected or confirmed threat. In such a case, the operator aims the light at the threat and illuminates the threat utilizing an electronically managed beam, whereby the area illuminated can be changed from wide to very narrow and intense depending on the distance from the spotlight to the threat. The spotlights can have a 2000-foot optimal beam length or greater, for example, whereby the 10,000 lumens can effectively saturate the threat in intense white light. Additionally, the operator can change the spotlight into a high-intensity strobe light, which will pulse several hundred times per minute to effectively blind the threat. For example, if the threat is a shooter, identified by the GDU systems and confirmed by LEO, a directive to actively neutralize the threat's ability to take an aimed shot into an event, can be given.

In various embodiments, each high intensity light is coaxially mounted with a camera and aimed in the same direction as the camera.

### Interoperability and Redundancy

The asymmetrical, panoramic security net according to the present disclosure can provide immediate, on-call, or sustained surveillance utilizing ground and aerial deployments of technology to observe, recognize, respond, and track the threat, or potential threat. The system can utilize integrated surveillance methods and active direct response technologies. The seamless, integrated, multi-layered observation, interdiction and tracking systems, are used in concert to be most effective. However, even if the panoramic net loses devices, for whatever reason, the remaining system elements will continue to be the eyes, ears and arms of police and rescue assets.

It will be appreciated that all devices used herein can be hardened against third party electrical interference. Further, all devices can perform individually, actively, and aggressively during periods of limited visibility, darkness, and adverse weather. As previously stated, some extremes in weather or environmental conditions may dictate a shift from reliance on one technology to another; however, the present system can be adapted as described herein.

As can be seen, the present system integrates various devices into a mobile product that can be deployed and provide for the immediate security of an event, inside and outside of the designated security area and/or known perimeter. This highly integrated system allows for auditory and visual data to be assimilated through multiple platforms where it is stored, analyzed, and broadcasted to first responders for immediate use before, during or after any event where large crowds have congregated for any purpose.

Additionally, all collected auditory and visual data can be safely stored for immediate use before, during or after the event.

Through all of the above, and as described herein, the presently disclosed system, device and method provide a technical solution to the challenge of deploying threat detection devices in, at and around event perimeters, collecting and analyzing the threat detection communications, and implementing a response protocol with appropriate interdiction and security responses.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, as exemplified above. The program code may execute entirely on a user's computer, partly on a user's computer, as a stand-alone software package, partly on a user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A security system, comprising:
at least one camera having a field of view outside of a known outer perimeter for an event;
at least one gunshot detection sensor positioned outside of the known outer perimeter;
at least one closed wireless network;
at least one processor; and
at least one memory device storing a plurality of instructions which, when executed by the at least one processor, cause the at least one processor to:
receive, via the at least one closed wireless network, at least one threat communication from the at least one camera or the at least one gunshot detection sensor;
determine, based on the at least one threat communication, a response protocol; and
issue, via the at least one closed wireless network to at least a first wireless device, a law enforcement communication or an emergency event communication according to the response protocol.

2. The security system of claim 1, wherein the at least one camera is grounded.

3. The security system of claim 1, wherein the at least one camera is mounted to an aerial mobile device.

4. The security system of claim 1, wherein the at least one gunshot detection sensor comprises acoustic and optical detection sensors.

5. The security system of claim 4, wherein the at least one gunshot detection sensor is secured to an aerial mobile device.

6. The security system of claim 1, further comprising at least one high intensity light source operatively linked to the at least one processor via the at least one closed wireless network.

7. The security system of claim 6, wherein the at least one high intensity light source is secured to an aerial mobile device.

8. The security system of claim 6, wherein the plurality of instructions, when executed by the at least one processor, further cause the at least one processor to issue, via the at least one closed wireless network, operational instructions to the at least one high intensity light source.

9. The security system of claim 1, wherein the issued communications are issued simultaneously.

10. The security system of claim 1, wherein the issued communications are issued at different times.

11. The security system of claim 1, wherein the determination of the response protocol is based on comparing, by the at least one processor, the received at least one threat communication with an archive of threat communications and retrieving the response protocol from an archive of response protocols based on the comparison.

12. The security system of claim 1, wherein the determination of the response protocol is based on categorizing, by the at least one processor, the received at least one threat communication within an archive of categorized threat communications and retrieving the response protocol from an archive of response protocols based on the categorized at least one threat communication.

13. The security system of claim 1, wherein the plurality of instructions, when executed by the at least one processor, further cause the at least one processor to receive, via an input device after determining the response protocol, input for the law enforcement communication and the emergency event communication.

14. A method for providing security, comprising the steps of:
detecting the presence of a potential threat via one or more of: at least one camera having a field of view outside of a known outer perimeter for an event, and at least one gunshot detection sensor positioned outside of the known outside perimeter;
receiving, by at least one processing unit in operative communication with the at least one camera and the at least one gunshot detection unit, at least one threat communication based on the detected presence of the potential threat;
comparing, by the at least one processing unit, the received at least one threat communication with an archive of threat communications;
developing, by the at least one processing unit, a response protocol based on the comparison; and
issuing, by the at least one processing unit, at least one communication to at least one wireless device according to the response protocol.

15. The method of claim 14, further comprising the step of issuing, by the at least one processing unit, operational instructions to at least one high intensity light source.

16. The method of claim 14, wherein the at least one communication is a law enforcement communication.

17. The method of claim 14, wherein the at least one communication is an emergency event communication.

18. The method of claim 14, wherein the at least one communication is a law enforcement communication and an emergency event communication, and wherein the at least one wireless device comprises a plurality of wireless devices, wherein each of the plurality of wireless devices receives either the law enforcement communication or the emergency event communication.

19. The method of claim 14, wherein the step of issuing the at least one communication is via a closed network permitting one-way communication from the at least one processing unit to the at least one wireless device.

20. A method for providing security, comprising the steps of:
detecting the presence of a potential threat via one or more of: at least one camera having a field of view outside of a known outer perimeter for an event, and at least one gunshot detection sensor positioned outside of the known outside perimeter;
receiving, by at least one processing unit in operative communication with the at least one camera and the at least one gunshot detection unit, at least one threat communication based on the detected presence of the potential threat;
categorizing, by the at least one processing unit, the received at least one threat communication within an archive of categorized threat communications;
developing, by the at least one processing unit, a response protocol based on the categorized at least one threat; and
issuing, by the at least one processing unit, at least one communication to at least one wireless device according to the response protocol.
